(19) United States
(12) Patent Application Publication
(10) Pub. No.: US 2026/0307636 A1
(43) Pub. Date: Oct. 8, 2026

(54) PNEUMATIC BRAKING DEVICE FOR VEHICLES AND METHOD FOR OPERATING A BRAKING DEVICE

(71) Applicant: ZF CV Systems Global GmbH, Bern (CH)

(72) Inventors: Janik Ricke, Uetze-Eltze (DE); Karl-Heinz Riediger-Janisch, Hannover (DE); Julian Van Thiel, Grossburgwedel (DE); Robert Otremba, Ronnenberg (DE); Jan Cohrs, Wietzendorf (DE); Thomas Dieckmann, Pattensen (DE)

(21) Appl. No.: 19/689,685

(22) Filed: May 27, 2026

Related U.S. Application Data
(63) Continuation of application No. PCT/EP2024/082347, filed on Nov. 14, 2024.

(30) Foreign Application Priority Data
Nov. 27, 2023 (DE) 10 2023 133 080.2

(51) Int. Cl. B60T 15/52; B60T 15/02

(52) U.S. Cl. CPC B60T 15/52; B60T 15/027; B60T 2220/04

(57) ABSTRACT

A method for operating a pneumatic braking device for vehicles with pneumatic brakes, which can be actuated via brake pressure and are vented via an outlet valve. In order to reduce the noise emission of the vehicle with pneumatic brakes when venting the brakes, a brake control unit controls the outlet valve according to a venting gradient, wherein the brake control unit, under consideration of the current vehicle control commands, makes a selection from at least two operating modes with different venting gradients and controls the outlet valve in a normal mode according to the venting gradients optimized with regard to reduced noise emissions during venting, and controls the outlet valve in a rapid venting mode according to the venting gradients optimized for rapid venting

### CROSS-REFERENCE TO RELATED APPLICATIONS

This application is a continuation application of international patent application PCT/EP2024/082347, filed Nov. 14, 2024, designating the United States and claiming priority from German application 10 2023 133 080.2, filed Nov. 27, 2023, and the entire content of both applications is incorporated herein by reference.

### TECHNICAL FIELD

The disclosure relates to a method for operating a braking device for vehicles with pneumatic brakes, which are released by venting via an outlet valve, wherein a brake control unit controls the outlet valve according to a predetermined venting gradient. The disclosure also relates to a braking device for vehicles with pneumatic brakes. The disclosure also relates to a vehicle.

### BACKGROUND

In commercial vehicles, the wheels are usually braked via pneumatically operated wheel brakes. To operate a pneumatic brake, brake pressure is applied via an inlet valve and the brake is vented by correspondingly controlling an outlet valve.

Venting generates noises that are particularly noticeable when the brake is released, as the brake pressure is reduced significantly. The noises are often perceived as disturbing in the vicinity of the vehicle, especially when venting at a standstill, for example when releasing a parking brake, the hold function of a service brake (“auto-hold”) or activating a parking brake by venting.

In principle, the noise could be reduced if the outlet valves were controlled with flatter venting gradients, that is, if the pressure reduction during venting were carried out more slowly. In many situations, however, slower venting is not sufficient to achieve the desired vehicle behavior. In particular, slower venting would often not correspond to the vehicle control requested by the driver.

### SUMMARY

It is an object of the disclosure to reduce the noise emission of a vehicle with pneumatic brakes when venting the brakes.

This object is, for example, achieved by a method for operating a braking device for vehicles with pneumatic brakes and a brake control unit configured to receive vehicle control commands and to actuate a respective brake via a brake pressure and to vent the respective brake via an outlet valve. The method includes: selecting, via the control unit and under consideration of current vehicle control commands, from at least two operating modes with different venting gradients, wherein the at least two operating modes include a normal mode and a rapid venting mode; and, controlling, via the control unit, the outlet valve in the normal mode according to first venting gradients which are optimized with regard to reduced noise emissions during venting and in a rapid venting mode according to second venting gradients optimized for venting.

The object is, for example, also achieved by a brake device for vehicles with pneumatic brakes which can be actuated via brake pressure and being configured to be vented via an outlet valve. The brake device includes: a brake control unit for controlling the outlet valve according to predetermined venting gradients, wherein the brake control unit is configured to receive vehicle control commands and, taking into account the vehicle control commands, to make a selection from at least two operating modes with different ones of the predetermined venting gradients, wherein the at least two operating modes include a normal mode and a rapid venting mode; the predetermined venting gradients including first venting gradients optimized with regard to reduced noise emissions during venting and second venting gradients optimized for rapid venting; the brake control unit being further configured to control the outlet valve in the normal mode according to the first venting gradients; and, the brake control unit being further configured to control the outlet valve in a rapid venting mode according to the second venting gradients.

In addition, a vehicle having the features of an outlet valve; pneumatic brakes configured to be actuated via brake pressure and being configured to be vented via the outlet valve, a brake device for the pneumatic brakes including a brake control unit for controlling the outlet valve according to predetermined venting gradients, wherein the brake control unit is configured to receive vehicle control commands and, taking into account the vehicle control commands, to make a selection from at least two operating modes with different ones of the predetermined venting gradients, wherein the at least two operating modes include a normal mode and a rapid venting mode; the predetermined venting gradients including first venting gradients optimized with regard to reduced noise emissions during venting and second venting gradients optimized for rapid venting; the brake control unit being further configured to control the outlet valve in the normal mode according to the first venting gradients; and, the brake control unit being further configured to control the outlet valve in a rapid venting mode according to the second venting gradients achieves the above object.

According to the disclosure, after evaluating the current vehicle control commands it receives, the brake control unit selects from at least two operating modes with different venting gradients. In a normal mode, it controls the outlet valve according to venting gradients which are specified for the quietest possible venting in order to reduce noise emissions during venting, and in rapid venting mode according to venting gradients optimized for rapid venting. The venting gradient is understood here as the temporal progression of pressure reduction during brake venting, which is caused by the specific control of the outlet valve with a corresponding control signal. The venting gradients, which are optimized with regard to reduced noise emissions, generally correspond to a longer venting process than would be possible for venting and is also intended in rapid venting mode. Slower venting generally results in significantly quieter venting noises.

Based on the results of the evaluation, the disclosure distinguishes between rapid venting mode, in which venting gradients are specified for rapid venting, and normal mode, in which venting gradients optimized for low noise emissions are specified, that is, quiet but slower venting takes place. In this way, rapid ventilation with corresponding noise emissions only occurs in exceptional cases when the vehicle control commands make this necessary.

The vehicle control commands are the driver's messages about his control decisions or requirements for the vehicle's operating equipment, which he communicates by operating the pedals in the driver's cab. Consequently, when selecting the operating mode with different venting gradients, the actuation signals of the brake pedal and/or the drive signal are evaluated. In manual transmission vehicles, the actuation of the clutch can also be advantageously included in the evaluation and selection of the intended operating mode with different ventilation gradients.

In the case of vehicle control commands from a driver assistance system or a virtual driver, the signals “release brake” and/or an acceleration request are advantageously evaluated in order to select the operating mode and the venting gradients associated with the operating mode.

Accordingly, for the selection of the operating mode according to the disclosure with venting gradients provided for the operating mode, a variable, that is, an mode selection variable, is derived from the vehicle control commands, from which conclusions can be drawn about the vehicle behavior desired by the driver. The operating mode is selected on the basis of the operating mode selection variable. The mode selection variable is advantageously derived from vehicle control commands for the current actuation of the pedals, in particular the brake pedal and/or the accelerator pedal. The mode selection variable can be monitored as the position of the relevant control pedal or a movement variable, for example the speed of change of the position of the control pedal or a variable derived from the speed. The evaluation of the variable ensures that situations in which venting must take place as quickly as possible are distinguished from situations in which venting gradients are controlled that are optimized with regard to noise generation during venting. In order to derive the mode selection variable for determining the venting gradient, the brake control unit uses a connection to each of the control pedals to receive their position sensor signals.

To derive the mode selection variable from the vehicle control commands, a normal value is specified for the travel distance of the relevant control pedal and the time in which the travel distance is covered during actuation. During evaluation, the deviation from the normal value is assessed with regard to the selection of the venting gradient. If the evaluation shows that the brake pedal, for example, travels a certain distance in a comparatively short time, this indicates the need for rapid venting, in contrast to a comparatively long time for the brake pedal to move. If the brake pedal is moved more slowly over the pedal travel, there is time for slower venting, so that in this case the evaluation leads to the selection of a noise-optimized venting gradient in normal mode.

In a preferred embodiment of the disclosure, a movement variable of the change in the position of the brake pedal is evaluated to select the operating mode and corresponding venting gradients in order to choose between a venting gradient for rapid venting, that is, rapid venting mode, and another operating mode in which venting gradients optimized with regard to noise generation are controlled.

In a further embodiment, the position of the accelerator pedal and/or a movement variable of the change in the position of the accelerator pedal is evaluated. The demand for drive power by pressing the accelerator pedal indicates a need for brake venting. The evaluation of the variable determined by the accelerator pedal is particularly advantageous and meaningful when combined with the evaluation of the variable determined by the brake pedal. Conclusions are drawn from pedal changes or the interaction of the pedals as to whether the venting gradient should be specified in accordance with rapid venting mode and rapid venting should be effected, or whether a noise-optimized venting gradient can be specified.

In a manual transmission vehicle, the clutch pedal is used as an additional data source in the evaluation and selection of optimal venting gradients. If, for example, the brake is released but the clutch pedal has not been depressed, there is no desire to set the vehicle in motion, that is, the driver simply wants to release the brake while stationary. The same applies if the driver is still pressing 100% on the clutch pedal. Or has been doing so for a long time.

In the preferred embodiment of the disclosure, a predetermined limit value for the mode selection variable is used in the mode selection to distinguish between the rapid venting mode and at least one other operating mode in which venting gradients optimized for low noise emissions are specified. If several operating modes are provided in addition to the rapid venting mode, several limit values are determined accordingly for evaluating the mode selection variable and delimiting the respective operating mode with individually specified venting gradients, and these are specified to the brake control unit.

An embodiment of the reduction in noise emission during venting by specifying optimized venting gradients is achieved when, within normal mode, further operating modes with individual venting gradients are selected depending on the mode selection variable, which is derived from the vehicle control commands, that is, determined by a driver by actuating at least one control pedal. The driving situation can also be taken into account, in particular whether the vehicle is traveling at low speed or even standing still. Noise-optimized venting gradients are particularly advantageous when the vehicle is stationary, as venting noises can be particularly disturbing in this situation, for example when braking at a stop or when the service brake is in auto-hold mode. If the driver releases the brake while stationary, noise can be significantly reduced via slower venting and a correspondingly flat venting gradient.

The brake venting according to the disclosure, based on a venting gradient that is selected depending on the actuation of at least one pedal, in particular the brake pedal, is particularly advantageous in commercial vehicles, especially trucks or buses.

### BRIEF DESCRIPTION OF DRAWINGS

The disclosure will now be described with reference to the drawings wherein:

FIG. 1 shows a pneumatic and electrical diagram of an example of a pneumatic brake system for a commercial vehicle; and,

FIG. 2 shows a flow chart of an example of a method for operating a braking device according to FIG. 1.

### DETAILED DESCRIPTION

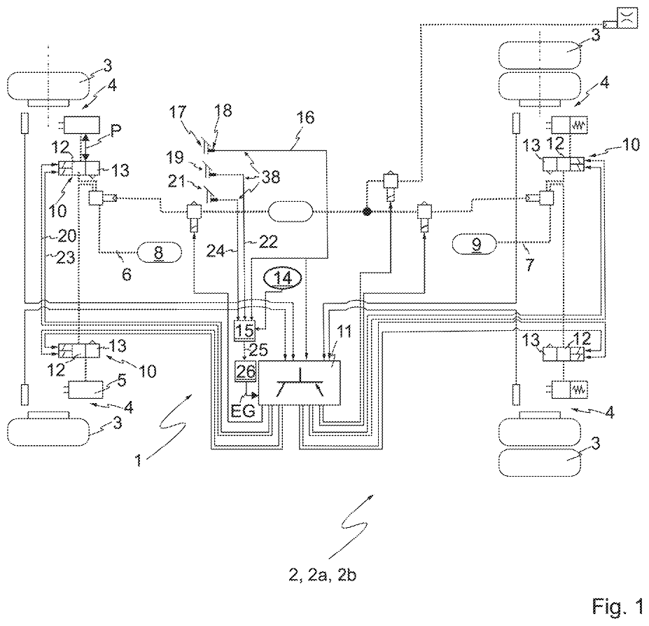

FIG. 1 shows an electrical-pneumatic diagram of a pneumatic braking device 1 of a vehicle 2, which is a commercial vehicle 2a. In the embodiment shown, the vehicle is a bus 2b equipped with a stop braking function. Electrical lines are shown with solid lines and pneumatic lines with dotted lines. To brake the wheels 3, each wheel 3 is assigned a brake 4, which can be actuated pneumatically via brake cylinders 5. The brakes 4 exert a braking force on the rotating wheel 3 in accordance with the pneumatic brake pressure P applied to the brake cylinder 5. In the embodiment shown, the wheel brakes 4 of the front axle are assigned to a common first brake circuit 6, while the wheel brakes 4 of the rear axle can be actuated via a second brake circuit 7. A first pressurized medium reservoir 8 is assigned to the first brake circuit 6 and connected to the brake cylinders 5 of the brakes 4 on the front axle. The second brake circuit 7 of the rear axle is supplied with pressurized medium via a second pressurized medium reservoir 9. The second brake circuit 7 is constructed analogously to the first brake circuit 6.

Each brake cylinder 5 of a brake 4 is connected upstream to a pressure control valve 10, which can be controlled electrically. The pressure control valves 4 are connected to a brake control unit 11 to receive control signals. The brake control unit 9 is configured and intended to influence the brake pressure P of the brakes 4 as required. In the embodiment shown, the pressure control valves 10 are each a combination of at least two solenoid valves, namely an inlet valve 12 and an outlet valve 13. The inlet valve 12 is used here in principle to increase the pressure or to maintain the pressure in the respective brake cylinder 5, while the outlet valve 13 is opened to reduce the brake pressure and vent the brake 4, that is, specifically the respective connected brake cylinder 5. The inlet valve 12 and the outlet valve 13 are preferably electrically controlled 2/2-way valves.

The brake control unit 11 takes into account vehicle control commands 38 for controlling the inlet valves 12 and the outlet valves 13, which are specified by the driver of the vehicle 2 via control pedals in the driver's cab, namely a brake pedal 18, an accelerator pedal 22 and, in the case of a manual transmission vehicle, a clutch pedal 21. When a braking request is detected, the brake control unit 11 sets a corresponding brake pressure P at the brakes 3 and outputs control signals 20 for at least the inlet valves 12. The braking request is communicated by the driver of the vehicle 2 via a brake signal 16 from the brake signal transmitter 17 of the brake pedal 18. By pressing the accelerator pedal 22, the driver communicates a driving request. The braking request and/or driving request may also be specified by a virtual driver, for example in autonomous driving, or by an external braking request from a driver assistance or stability system 14 of the commercial vehicle 2a. A braking request is also the request for an auto-hold function of the braking device 1 or a stop brake, which have in common that a certain braking pressure is applied to the actuators of the brake, with which the vehicle 2 is held at a standstill, and this braking pressure is enclosed until the brake 4 is released. In the case of a parking brake, pneumatic pressure is applied to release the brake, which is vented to apply the brake, In the same way as a braking request.

The brake 4 is released by venting through the opening of the respective outlet valve 13, which is actuated for this purpose by the brake control unit 11 with control signals 23. A release request can result from an evaluation of the brake signal 16 from the brake pedal 18 or from a virtual driver's specification.

The brake control unit 11 determines the control signals 23 for controlling the outlet valve 13 according to a venting gradient EG, that is, a specification that determines the temporal dynamics of the opening of the outlet valve 13. Several operating modes are provided, which have different venting gradients EG. For the operating mode selection 26, an mode selection variable 25 is derived 26 from the vehicle control commands 38. The mode selection variable 25 is therefore characterized by the actuation of at least one control pedal. For the derivation 26 of the mode selection variable 25 and thus of the venting gradient EG, the brake signal 16 of the brake pedal 18 is used and evaluated with regard to the vehicle behavior desired by the driver. In the embodiment shown, the evaluation 15 also takes into account the drive signal 22 of the accelerator pedal 19, with which the driver can request propulsion of the vehicle 2, with regard to the determination of the venting gradient EG. In a manual transmission vehicle, a clutch signal 24 from a clutch pedal 24 is also used for the derivation 15 of the mode selection variable 25 and ultimately for the evaluation of the driver's operating behavior.

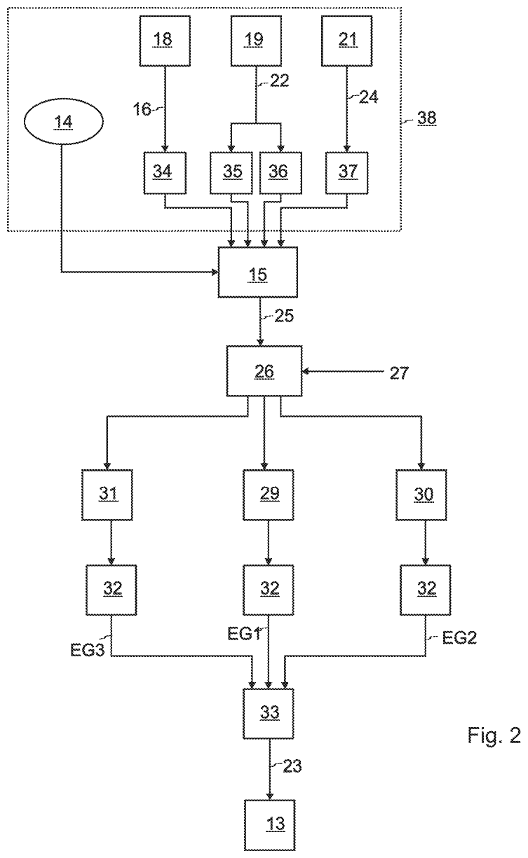

The specification of the venting gradient and determination of the control signal 23 for the outlet valve 13 is explained below with reference to FIG. 2. The same reference signs as in FIG. 1 are used for the same features. If the current actuation of one or more pedals results in the need to reduce the applied brake pressure by venting the brake, a specific operating mode 29, 30, 31 is determined and a venting gradient EG1, EG2, EG3 provided for in the operating mode determines which of the outputs 33 of the control signal 23 is used as a basis for the outlet valve 13. The operating mode selection 26 and thus the determination of the venting gradient EG1, EG2, EG3 is determined by the evaluation 15 of at least one mode selection variable 25, which is characterized by the current actuation of the control pedals. In the operating mode selection 26, a distinction is made between a rapid venting mode 30, in which venting gradients EG are specified for rapid venting, and at least one other operating mode, in which venting gradients optimized for low noise emissions are specified. In the embodiment shown, normal mode 29 is provided, as well as a further operating mode 31 for standstill or slow driving (standstill mode 31), Standstill mode 31 is intended for a stop brake function or an auto-hold function of the brake system when the brake is to secure the vehicle 2, that is, in the embodiment, the bus 2c equipped with a stop brake, at a standstill.

In order to select the operating mode 26 and thus choose between a venting gradient EG2 for rapid venting, that is, rapid venting mode 30, and another operating mode in which venting gradients EG1, EG3 optimized with regard to noise generation are selected, the change 34 in the position of the brake pedal 18 is derived from the brake signal 16 and determined as the decisive mode selection variable 26. The change 34 in the position of the brake pedal 18 is defined as a movement variable, that is, the speed of movement of the brake pedal 18 or another movement variable derived from it, which contains qualitative information about the movement of the brake pedal 18. Optionally, a normal value for the travel distance of the brake pedal 18 is specified and the time taken to cover the travel distance when the pedal is pressed is considered. During the evaluation and derivation 15 of the mode selection variable 25 and thus the selection of the ventilation gradient EG1, EG2, EG3 to be controlled, the deviation from the normal value is evaluated. In the embodiment, the distinction between rapid venting mode 30 and normal mode is then made by comparing the deviation determined from the normal value with a specified limit value 27.

In addition, when selecting the operating mode 26 and thus the ideal venting gradient EG1, EG2, EG3, the position of the accelerator pedal 22 and/or a movement variable of the change in the position of the accelerator pedal 22 is evaluated. Taking into account the information provided by the accelerator pedal 22 is particularly advantageous and meaningful if it is combined with the variables provided by the brake pedal 18 and the operating mode selection 26 is made on the basis of the combined evaluation of information from the accelerator pedal 22 and the brake pedal 18. Conclusions are drawn from pedal changes or the interaction of the pedals as to whether the venting gradient EG2 should be specified in accordance with rapid venting mode 30 and rapid venting should be effected, or whether a noise-optimized venting gradient EG1 can be specified. If the driver releases the brake pedal in a relatively short time, for example 0.3 seconds, and presses the accelerator pedal in a short transition time of less than 0.5 seconds, for example, this underlines the desire to start driving immediately. If no signal is received from the accelerator pedal, the brake has more time to vent and a noise-optimized venting gradient EG2 can be specified and controlled by the outlet valve 13.

The vehicle 2 shown is a manual transmission vehicle, wherein the clutch pedal 21 is used as an additional data source in operating mode selection 26 of the different operating modes with different venting gradients EG1, EG2, EG3. If, for example, the brake is released but the clutch pedal 21 has not been depressed, there is no desire to set the vehicle in motion, that is, the driver simply wants to release the brake while stationary.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1. Braking device
2. Commercial vehicle
3. Wheel
4. Brake
5. Brake cylinder
6. First brake circuit
7. Second brake circuit
8. First pressurized medium reservoir
9. Second pressurized medium reservoir
10. Pressure control valve
11. Brake control unit
12. Inlet valve
13. Outlet valve
14. Driver assistance system
15. Derivation
16. Brake signal
17. Brake transducer
18. Brake pedal
19. Accelerator pedal
20. Control signal inlet valve
21. Clutch pedal
22. Drive signal
23. Control signal outlet valve
24. Clutch signal
25. Mode selection variable
26. Operating mode selection
27. Limit value
28. Output control signal for outlet valve
29. Normal mode
30. Rapid vent mode
31. Standstill mode
32. Specification
33. Output control signal
34. Change in brake pedal position
35. Accelerator pedal position
36. Change in accelerator pedal position
37. Actuation of clutch pedal
38. Vehicle control commands
P Brake pressure
EG1 Venting gradient normal mode
EG2 Venting gradient rapid vent mode
EG3 Venting gradient standstill mode

1. A method for operating a braking device for vehicles with pneumatic brakes and a brake control unit configured to receive vehicle control commands and to actuate a respective brake via a brake pressure and to vent the respective brake via an outlet valve, the method comprising:
selecting, via the control unit and under consideration of current vehicle control commands, from at least two operating modes with different venting gradients, wherein the at least two operating modes include a normal mode and a rapid venting mode; and,
controlling, via the control unit, the outlet valve in the normal mode according to first venting gradients which are optimized with regard to reduced noise emissions during venting and in a rapid venting mode according to second venting gradients optimized for venting.

2. The method of claim 1, wherein the vehicle control commands are for at least one of accelerating and braking.

3. The method of claim 1, wherein said selecting from at least two modes is made on a basis of a mode selection variable which is derived from the vehicle control commands of a current actuation of at least one of a brake pedal and an accelerator pedal.

4. The method of claim 3, wherein said selecting from at least two modes is derived from a change in a position of the brake pedal.

5. The method of claim 3, wherein said selecting from at least two modes is derived from at least one of a position of the accelerator pedal and a change in a position of the accelerator pedal.

6. The method of claim 3, wherein, during selecting from at least two modes, a predetermined limit value for the mode selection variable is used to distinguish the rapid venting mode from the normal mode in which venting gradients optimized with regard to reduced noise emissions are specified.

7. A brake device for vehicles with pneumatic brakes which can be actuated via brake pressure and being configured to be vented via an outlet valve, the brake device comprising:
a brake control unit for controlling the outlet valve according to predetermined venting gradients, wherein said brake control unit is configured to receive vehicle control commands and, taking into account the vehicle control commands, to make a selection from at least two operating modes with different ones of said predetermined venting gradients, wherein said at least two operating modes include a normal mode and a rapid venting mode;
said predetermined venting gradients including first venting gradients optimized with regard to reduced noise emissions during venting and second venting gradients optimized for rapid venting;
said brake control unit being further configured to control the outlet valve in said normal mode according to said first venting gradients; and,
said brake control unit being further configured to control the outlet valve in a rapid venting mode according to said second venting gradients.

8. A vehicle comprising:
an outlet valve;
pneumatic brakes configured to be actuated via brake pressure and being configured to be vented via the outlet valve,
a brake device for said pneumatic brakes including a brake control unit for controlling the outlet valve according to predetermined venting gradients, wherein said brake control unit is configured to receive vehicle control commands and, taking into account the vehicle control commands, to make a selection from at least two operating modes with different ones of said predetermined venting gradients, wherein said at least two operating modes include a normal mode and a rapid venting mode;
said predetermined venting gradients including first venting gradients optimized with regard to reduced noise emissions during venting and second venting gradients optimized for rapid venting;
said brake control unit being further configured to control the outlet valve in said normal mode according to said first venting gradients; and,
said brake control unit being further configured to control the outlet valve in a rapid venting mode according to said second venting gradients.

9. The vehicle of claim 8, wherein the vehicle is a bus.

10. The vehicle of claim 8, wherein the vehicle is a commercial vehicle.
